(19) United States
(12) Patent Application Publication
(10) Pub. No.: US 2025/0246014 A1
(43) Pub. Date: Jul. 31, 2025

(54) Uniquely Identifiable Items and Audio/Visual Content Distribution

(71) Applicant: Peter Anthony Angritt, New Braunfels, TX (US)

(72) Inventor: Peter Anthony Angritt, New Braunfels, TX (US)

(21) Appl. No.: 18/507,216

(22) Filed: Jan. 29, 2024

(51) Int. Cl. G06V 20/80

(52) U.S. Cl. CPC G06V 20/80

(57) ABSTRACT

Using a proprietary web application, content of an audio/visual nature can be accessed through the [detection of a pre-designated sensory cue or the] scanning of a physical item of any kind, such as personalized souvenir items, music album or book cover, or movie poster/cover art. This process allows for sensory cues, such as recorded tonal audio, voice or physical movements, as well as physical items, such as media cover items and gifts which can be used as decorations,—collectables, or other purposes to be used for the distribution of digital media content without the need for the complete physical media such as CDs, DVDs, complete comic books or graphic novels.

The invention is a process through which audio and video content, primarily in digital formats, is distributed through a software application, which correlates specifically identifiable items to only authorized media, in order to provide customers access to media using a previously undeveloped distribution channel.

The software application is created through standard programming languages such as Java, Javascript, Python, Json and/or C++. It can be implemented on any compatible computer operating system such as Apple, Microsoft or Linux. The software application uses custom algorithms, database functionality and artificial intelligence (AI) technology to scan items [in various sensory forms in order to] correlate them with specific media content to be presented through in-device memory or online download.

Items can be produced using typical methods currently used to make movie posters, music disc (vinyl, cd, dvd, etc.) album covers, t-shirts, comic book cover art, and souvenirs of all kinds including personalized items such as photos, wall hangings and other works. For this purpose items can include non-physical sensory cues such, for example, as specific sounds or physical movements designed and recorded to serve as prompts for media presentation.

The particular portions of the process which are claimed to be an invention include, but are not limited to, software application's ability to scan and recognize items, and correlate them to the correct media, if any, to be presented.

Applicant respectfully requests that a timely Notice of Allowance be issued in this case.

1. I claim the creation of a new and previously undeveloped and unused content distribution method using existing technologies such as the internet connectivity, computer software applications and devices equipped with digital cameras, digital audio and video, original algorithms, artificial intelligence processing, and augmented reality (AR) coupled with any uniquely identifiable item such as a physical object or sensory cues.
The particular portions of the process which are claimed to be an invention include, but are not limited to, software application's ability to scan and recognize uniquely identifiable items such as physical items and sensory cues, correlate them, on the basis of algorithmic and AI information processing, to the correct media, if any, to be distributed.
